(19) United States
(12) Patent Application Publication
(10) Pub. No.: US 2007/0192730 A1
(43) Pub. Date: Aug. 16, 2007

(54) Electronic device, computer program product and method of managing application windows

(76) Inventors: Vesa Simila, Haukipudas (FI); Heikki Ojaniemi, Oulu (FI)

Correspondence Address: Hollingsworth & Funk, 8009 34th Avenue South, Suite 125, Minneapolis, MN, 55425, US

(21) Appl. No.: 10/591,758

(22) PCT Filed: Mar. 18, 2005
(86) PCT No.: PCT/FI05/50094

§ 371 Date: Sep. 1, 2006

(30) Foreign Application Priority Data
Mar. 24, 2004 (FI) 20040446

(51) Int. Cl. G06F 3/048

(52) U.S. Cl. 715/788; 715/803

(57) ABSTRACT

A method of managing application windows in an electronic device, an electronic device, and a computer program product. The electronic device comprises a processing unit for controlling functions of the device, a display connected to the processing unit for showing application windows, and an input device for issuing control commands, the processing means being configured to open the application windows of at least two different application programs onto the display. The processing unit is configured to indicate activation of a grip area for managing application windows on the display, detect a change in the location of the activated grip area on the display, indicated by an input device, and change the size of at least two application windows on the basis of the change in the location of the grip area.

### FIELD

The invention relates to a method of managing application windows in an electronic device, an electronic device and a computer program product.

### BACKGROUND

Various displays, such as touch screens, play an increasingly important role in electronic devices. Displays are used for displaying various application windows and icons. A display may often be the only user interface provided in an electronic device to enable the operation of the device to be controlled. However, various portable devices, for example, are limited in size, which means that the sizes of displays used in such devices are also often far from those of the displays used in corresponding computers. The limited sizes of displays, among other things, present various problems to users.

It is often difficult for the users to manage application windows open on a display. It is difficult to manage several simultaneously open application windows in particular. In order to change e.g. the sizes of open application windows such that each window would still be seen appropriately, the user has to adjust each window separately in order to produce a desired view onto the display. It is also possible that the size of some application windows may only be adjusted from beyond several menus and menu functions.

### BRIEF DESCRIPTION

An object of the invention is to provide an improved method, an improved electronic device and an improved computer program product. This is achieved by a method of managing application windows in a electronic device, comprising: opening the application windows of at least two different application programs onto a display. The method of the invention comprises detecting activation of a grip area for managing application windows on the display; detecting a change in the location of the activated grip area on the display, indicated by an input device; and changing the size of at least two application windows on the basis of the change in the location of the grip area.

The invention further relates to an electronic device comprising a processing unit for controlling functions of the device, a display connected to the processing unit for showing application windows, and an input device for issuing control commands, the processing unit being configured to open the application windows of at least two different application programs onto the display. The processing unit is further configured to detect activation of a grip area for managing application windows on the display; detect a change in the location of the activated grip area on the display, indicated by the input device; and change the size of at least two application windows on the basis of the change in the location of the grip area.

The invention also relates to a computer program product which encodes a computer process to manage application windows, the computer process comprising: opening the application windows of at least two different application programs onto a display. The computer process further comprises detecting activation of a grip area for managing application windows on the display; detecting a change in the location of the activated grip area on the display, indicated by an input device; and changing the size of at least two application windows on the basis of the change in the location of the grip area.

The invention yet further relates to an electronic device comprising processing means for controlling functions of the device, means for showing application windows, and input means for issuing control commands, the processing means opening the application windows of at least two different application programs onto a display. The processing means detect activation of a grip area for managing application windows on the display; detect a change in the location of the activated grip area on the display, indicated by the input means; and change the size of at least two application windows on the basis of the change in the location of the grip area.

The invention provides several advantages. The sizes of several application windows may be quickly and easily adjusted employing a single procedure. It becomes possible to simultaneously manage several application windows in an easily-adopted manner. This, in turn, considerably improves the usability of a device.

### LIST OF DRAWINGS

The invention is now described in closer detail in connection with preferred embodiments and with reference to the accompanying drawings, in which

FIG. 1 shows an example of an electronic device,

FIG. 2 shows an example of a method of managing application windows in a electronic device, and

FIGS. 3A, 3B, 4A, 4B, 5A and 5B show examples of user interfaces of an electronic device.

### DESCRIPTION OF EMBODIMENTS

The invention may be applied to electronic devices, such as a mobile station, used as a terminal device in telecommunication systems comprising one or more base transceiver stations and terminal devices communicating with the base transceiver stations. In some embodiments of the invention, such a device comprises a possibility of short-range communication, such as a Bluetooth chip or a transceiver functionality implemented by an infrared or a WLAN connection. The electronic device is e.g. a mobile telephone, a computer, a handheld computer or an intelligent telephone. The invention may also be applied to PDA (Personal Digital Assistant) devices which themselves comprise the necessary telecommunication properties, or to PDA devices which may be connected e.g. to a mobile telephone for a network connection. The electronic device may also be a computer or a PDA device comprising no telecommunication properties.

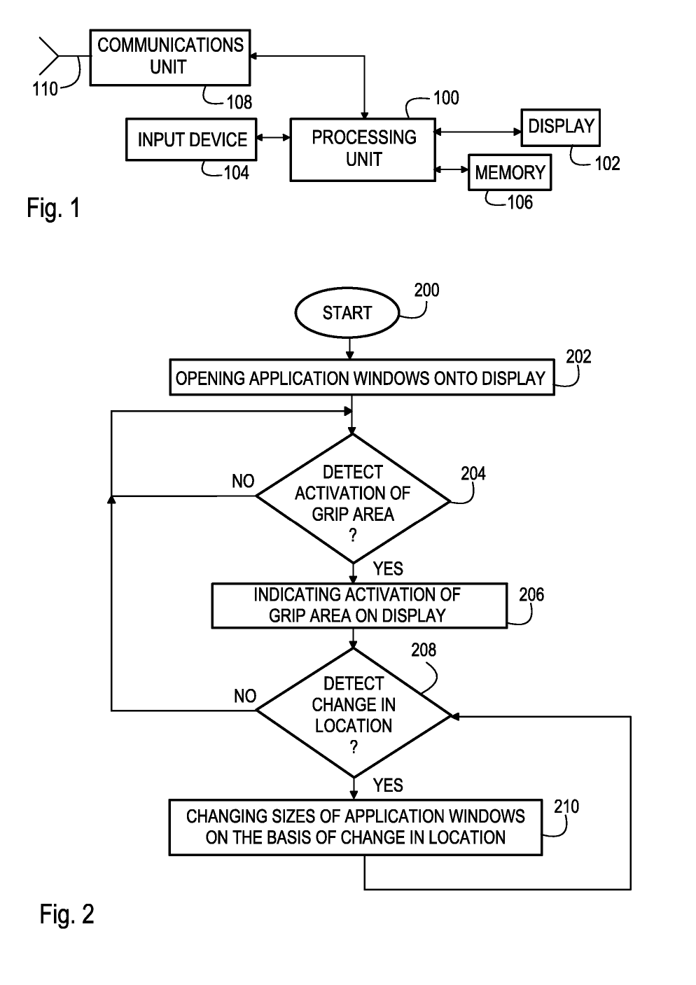

FIG. 1 is a block diagram showing the structure of an electronic device. A processing unit 100, which is typically implemented by means of a microprocessor and software or separate components, controls the basic functions of the device. The user interface of the device comprises an input device 104 and a display 102, such as a touch screen. In a touch screen, the display 102 may be provided with a contact surface thereabove. It is also possible to implement the touch screen such that the display 102 is provided actually with nothing thereabove but the contact point is detected by other means, e.g. capacitively or acoustically. Typically, the display 102 is a liquid crystal display.

The device may further comprise several other user interface parts which may differ in kind and number, depending on the type of the device. The electronic device shown in FIG. 1, such as a mobile station, may also comprise common means 108, which include speech and channels coders, modulators and RF parts, to implement the functions of the device. The device may further comprise an antenna 110 and a memory 106.

The functions of the device are controlled by the input device 104. The input device 104 may be e.g. a mouse or a keypad. When using a mouse, an arrow, a character or a symbol may indicate the location of the cursor of the mouse on the display 102. It is also possible that the display 102 in itself constitutes an input device 104 which is implemented e.g. by means of a contact surface. The desired functions may be selected e.g. by touching the objects shown on the display. The contact may be provided e.g. with a pen, a stylus or a finger.

The processing unit 100 controls the functions of the device. The processing unit 100 is configured to show application windows of different application programs on the display 102. The processing unit 100 receives control commands from the input device 104. The application windows may be views e.g. into certain application programs to be run in the device, such as a word processing program or a calendar. An application window may also be a view e.g. into an Internet application or any application view that can be shown on the display 102.

Application windows are managed such that the desired functions are first selected by using the input device 104. Next, the processing unit 100 interprets the detected selections, carries out certain software procedures accordingly, and shows the results of the conducted software procedures on the display 102.

In an embodiment, the processing unit 100 first opens the application windows of at least two different application programs onto the display 102. The processing unit 100 is configured to detect activation of a grip area for managing application windows on the display 102. The grip area resides e.g. within a free area between the application windows, or e.g. at a predetermined location on the display 102, such as in a bar or at a top or a bottom corner of the display 102. The processing unit 100 interprets that the grip area has been activated on the basis of signals received from the input device 104.

The user e.g. moves the cursor of the mouse operating as the input device 104 at or in the vicinity of the grip area within the area of the display 102, in which case the processing unit 100 interprets that the grip area has been activated. The processing unit 100 may also show the activation on the display 102 e.g. by changing the cursor of the mouse being shown on the display 102 into a form indicating activation of the grip area. The activation of the grip area may also be indicated by any other means, e.g. by means of a certain character or a symbol on the display 102. The processing unit 100 may detect the selection of the grip area for managing application windows e.g. by means of a pen, a stylus or a finger operating as the input device 104. The processing unit 100 is also configured to change the size of at least two application windows on the basis of a change in the location of the grip area.

The software operating instructions coding the computer process for managing application windows may be stored in the memory of the device 106. In an embodiment, the computer process opens the application windows of at least two different application programs onto the display, detects the activation of the grip area for managing the application windows on the display, detects a change in the location of the activated grip area on the display, indicated by the input device, and changes the size of at least two application windows on the basis of the change in the location of the grip area.

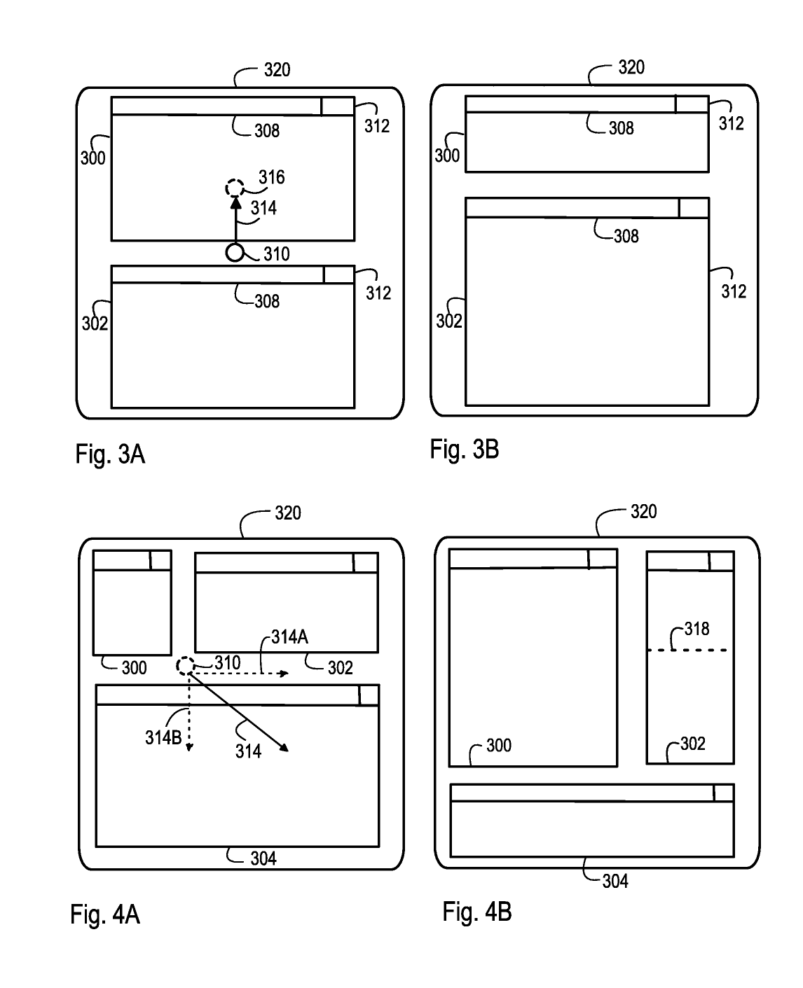

FIG. 2 shows an example of a method of managing application windows in an electronic device.

The method starts in 200. In 202, the application windows of at least two different application programs are opened onto a display. If, in 204, activation of a grip area is detected, indicated by an input device, the process moves to 206, wherein the activation of the grip area is shown on the display. It is possible, however, that the activation of the grip area is not shown on the display at all, and the process moves from 204 directly to 208. If, in 208, a change is detected in the location of the grip area on the display, the process moves to 210, wherein the size of at least two application windows is changed on the basis of the change in the location. From 210 the process returns to 208. If, in 208, no change is detected in the location of the grip area on the display, the process returns to 204 to monitor the activation of the grip area, and from there further to 206 and 208. The process may continue to detect a change in the location of the grip area and change the sizes of the application windows e.g. for as long as the grip area is activated.

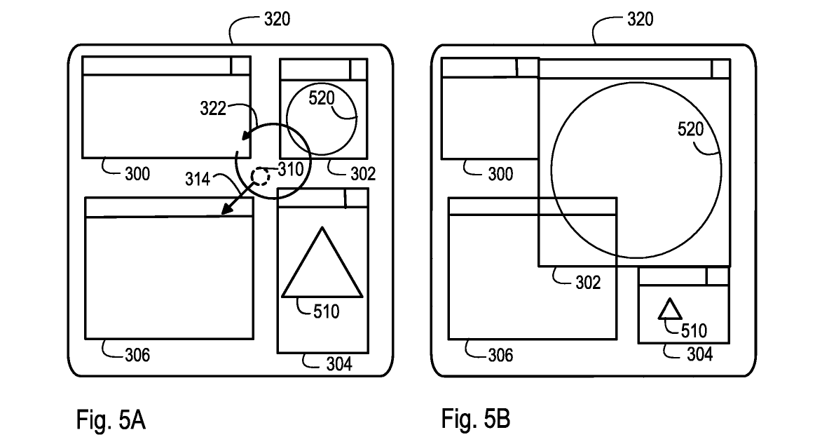

Next, more detailed examples of some embodiments will be shown in FIGS. 3A, 3B, 4A, 4B, 5A and 5B. FIGS. 3A, 3B, 4A, 4B, 5A and 5B show examples of user interfaces of an electronic device.

FIGS. 3A and 3B show a display 320 of an electronic device and application windows 300 and 302 of two different application programs within the area of the display. The application windows 300, 302 may comprise different areas, each having a certain purpose. Views to the application programs may be shown e.g. in the largest area 308 of the application windows 300, 302. The application windows 300, 302 may also comprise bars 312 or menus for accessing different functions and/or for showing information.

FIG. 3A shows a grip area 310 within an area between the application windows 300, 302. The grip area 310 may also reside e.g. in the bar 312 of the application window 300, 302, or e.g. at the edges of the application window 300, 302. The grip area 310 may e.g. extend over the entire area between the application windows 300, 302. The grip area 310 may be activated e.g. by moving the cursor of a mouse or a pen to any point within the grip area 310 or in to the vicinity of the grip area 310, e.g. to the area between the application windows 300, 302. It is possible that the activation of the grip area 310 is shown on the display 320 e.g. by means of a character or a symbol.

In the example of FIG. 3A, a user wishes to change the sizes of the application windows 300, 302 such that the size of the application window 302 is increased while the size of the application window 300 is reduced. After the grip area 310 has been activated, the user moves the location of the grip area 310 on the display 320 for changing the sizes of the application windows 300, 302. In FIG. 3A, the grip area 310 is moved in a direction indicated by an arrow 314. The movement of the grip area 310 on the display 320 is detected in the device by means of an input device. If the input device is a mouse, the user may e.g. after the activation of the grip area 310 press down a button of the mouse and draw the mouse in a desired direction, in which case the grip area 310 changes its location along with the draw. Releasing the button of the mouse, in turn, may stop the change in the location of the grip area 310. When the input device is e.g. a touch screen, the grip area 310 may be moved e.g. by selecting, using a pen, a stylus or a finger, the grip area 310 and moving it in a desired direction.

The device thus detects a change in the location of the grip area 310 indicated by the input device. On the basis of the change in the location of the grip area 310, the device changes the sizes of the application windows 300, 302. In FIG. 3A, the grip area 310 has been moved in a direction indicated by the arrow 314 from a first location 310 of the grip area 310 to a second location 316 of the grip area. FIG. 3B shows the display 320 and the application windows 300, 302 after the sizes of the application windows 300, 302 have been changed. FIG. 3B shows that the size of the application window 302 has been increased while the size of the application window 300 has been decreased. The sizes of the application windows 300, 302 may be changed in the same proportion with respect to one another e.g. such that the reduction in the size of the application window 300 is equivalent to the increase in the size of the application window 302. The extent to which the sizes of the application windows 300, 302 are changed, in turn, depends on the extent to which the location of the grip area 310 has changed on the display 320; e.g. such that the greater the distance between the first location 310 and the second location 316 of the grip area 310, the greater the extent to which the sizes of the application windows 300, 302 are changed.

The direction of motion of the grip area 310 also affects changing the sizes of the application windows 300, 302. A direction of motion of the grip area herein refers to a direction in which the grip area 310 is moved on the display 320. When, for example, the direction of motion 314 is perpendicular towards the bottom edge of the application window 300, as in FIG. 3A, the size of the application window 300 is decreased by moving the particular bottom edge of the application window 300 in the direction of motion 314 and by reducing the side edges of the application window 300 in the same proportion. On the other hand, if a straight line drawn in the direction of motion 314 of the grip area 310 forms an angle with the edges of the application window 300, 302, the application window 300, 302 may be increased or reduced by moving two determined edges of the application window 300, 302, e.g. the bottom and side edges, and by increasing or reducing the other edges in the same proportion. It is possible that the grip area 310 is moved in several different directions of motion at one single time of changing the sizes of the application windows 300, 302. Also in such a case, the sizes of the application windows 300, 302 are changed in a determined manner depending on a current direction of motion of the grip area 310. The sizes of the application windows 300, 302 are changed e.g. according as the location of the grip area 310 changes on the display 320. It is also possible that the device changes the sizes of the application windows 300, 302 at certain intervals or e.g. after the location of the grip area 310 has changed to a predetermined extent on the display 320.

FIGS. 4A and 4B show a second example comprising a display 320 of an electronic device and application windows 300, 302 and 304 within the area of the display 320. At least two of the application windows 300, 302, 304 are application windows of different application programs.

In an embodiment, the sizes of the application windows 300, 302, 304 are changed so as to make the changed application windows cover as large a surface area of the display 320 as possible. In FIG. 4A, for example, the grip area 310 is moved in the direction of motion of an arrow 314. Since the x and y components 314A and 314B of the direction of motion 314 of the grip area 310 recede from the application window 300, the size of the application window 300 is increased. Correspondingly, the y component 314B of the direction of motion of the grip area 310 points towards the application window 304, so the size of the application window 304 is decreased by moving the upper edge of the application window 304 downwards in the direction of the y component 314B. As to the x and y components 314A and 314B of the direction of motion 314 of the grip area 310, the direction of the x component 314A of the direction of motion 314 is towards the side edges of the application window 302. Hence, the application window 302 is changed by moving a side edge in the direction of the x component 314A of the direction of motion 314, in which case the size of the application window 302 is reduced. On the other hand, the direction of the y component 314B of the direction of motion 314 of the grip area 310 recedes from the application window 302. Hence, the application window 302 is also changed by moving the bottom edge of the application window 302 in the direction of the y component 314B, in which case the size of the application window 302 is increased.

It is thus possible that after changing the location of the grip area 310, as in FIG. 4B, the size of one or more application windows 300, 302, 304 may be almost the same or even the same as in the beginning. In the example of FIGS. 4A and 4B, however, the sizes of the application windows 300, 302, 304 may be changed e.g. such that the lower edge 318 of the application window 302 is not moved in the direction of the y component 314B of the direction of motion 314 of the grip area 310, in which case after the movement of the grip area 310, the size of the application window 302 would be considerably smaller than before.

FIGS. 5A and 5B show an example comprising a display 320 of an electronic device and application windows 300, 302, 304 and 306 within the area of the display 320. At least two of the application windows 300, 302, 304, 306 are application windows of different application programs.

In an embodiment, prior to changing the location of the grip area 310, the selection of the application windows to be changed from among the application windows 300, 302, 304, 306 is detected first, and only the size of the application windows to be changed is changed. In FIG. 5A, for example, application windows 300, 302 and 304 are selected to be the application windows to be changed. The application windows 300, 302, 304 to be changed may be selected e.g. by means of an input device. The user e.g. draws, with a mouse or a pen, a route 322 on the display 320, the route 322 running via the application windows 300, 302 and 304 to be changed, touching these windows. It is possible to select the application windows 300, 302, 304 to be changed also in other manners.

In FIG. 5A, the grip area 310 is moved in a direction of motion 314. In the application window 302, application window contents are shown in the form of a circle 520. In the application window 304, application window contents are shown in the form of a triangle 510. In an embodiment, the application window contents 510, 520 are scaled in proportions to the changes in the sizes of the application windows.

FIG. 5B shows a situation after changing the grip area. Now only the sizes of the application windows 300, 302, 304 to be changed have changed. The application window 306 is of the same size as before, being partly invisible under the application window 302. The application window contents 510, 520 have been scaled so that the circle 520 shown by the application window 302 is shown larger in FIG. 5B than in FIG. 5A, wherein the size of the application window 302 was smaller. The size of the application window 304, instead, is reduced, the triangle 510 included in the application window 304 being scaled to be a smaller triangle 510 in FIG. 5B, according to the reduction in size.

It can be seen in FIG. 5B that the edges of the changed application windows 300, 302, 304 come into contact with one another. It is also possible, however, that the sizes of the application windows 300, 302, 304 are changed such that the original distances therebetween remain.

Although the invention has been described above with reference to the example according to the accompanying drawings, it is obvious that the invention is not restricted thereto but can be modified in many ways within the scope of the accompanying claims.

1. A method of managing application windows in an electronic device, the method comprising:
opening the application windows of at least two different application programs onto a display;
detecting activation of a grip area for managing application windows on the display;
detecting a change in the location of the activated grip area on the display, indicated by an input device; and
changing the size of at least two application windows on the basis of the change in the location of the grip area.

2. The method as claimed in claim 1, further comprising showing the grip area for managing application windows on the display.

3. The method as claimed in claim 1, further comprising changing the sizes of the application windows during the change in the location of the activated grip area.

4. The method as claimed in claim 1, further comprising changing the sizes of the application windows such that the changed application windows cover as large a portion of the display as possible.

5. The method as claimed in claim 1, further comprising detecting selection of the application windows to be changed from among the opened application windows; and changing the size of the application windows to be changed only.

6. The method as claimed in claim 1, further comprising scaling the contents of the application windows in proportions to the changes in the sizes of the application windows.

7. The method as claimed in claim 1, wherein detecting a change in the location of the grip area comprises: detecting a direction of motion of the grip area from a first location of the grip area to a second location of the grip area as well as the distance between the first location and the second location, and changing the sizes of the application windows on the basis of the detected direction of motion and distance.

8. An electronic device comprising a processing unit for controlling functions of the device, a display connected to the processing unit for showing application windows, and an input device for issuing control commands, the processing unit being configured to open the application windows of at least two different application programs onto the display, and wherein the processing unit is further configured to: detect activation of a grip area for managing application windows on the display; detect a change in the location of the activated grip area on the display, indicated by the input device; and change the size of at least two application windows on the basis of the change in the location of the grip area.

9. The electronic device as claimed in claim 8, wherein the processing unit is configured to show the grip area for managing application windows on the display.

10. The electronic device as claimed in claim 8, wherein the processing unit is configured to change the sizes of the application windows during the change in the location of the activated grip area.

11. The electronic device as claimed in claim 8, wherein the processing unit is configured to change the sizes of the application windows such that the changed application windows cover as large a portion of the display as possible.

12. The electronic device as claimed in claim 8, wherein the processing unit is configured to detect selection of the application windows to be changed from among the opened application windows; and change the size of the application windows to be changed only.

13. The electronic device as claimed in claim 8, wherein the processing unit is configured to scale the contents of the application windows in proportions to the changes in the sizes of the application windows.

14. The electronic device as claimed in claim 8, wherein in detecting a change in the location of the grip area, the processing unit is configured to detect a direction of motion of the grip area from a first location of the grip area to a second location of the grip area as well as the distance between the first location and the second location, and to change the sizes of the application windows on the basis of the detected direction of motion and distance.

15. A computer program product which encodes a computer process to manage application windows, the computer process comprising: opening the application windows of at least two different application programs onto a display, the computer process further comprising:
detecting activation of a grip area for managing application windows on the display;
detecting a change in the location of the activated grip area on the display, indicated by an input device; and
changing the size of at least two application windows on the basis of the change in the location of the grip area.

16. An electronic device comprising: processing means for controlling functions of the device, means for showing application windows, and input means for issuing control commands, the processing means opening the application windows of at least two different application programs onto a display, wherein the processing means detect activation of a grip area for managing application windows on the display, detect a change in the location of the activated grip area on the display, indicated by input means, and change the size of at least two application windows on the basis of the change in the location of the grip area.
